(19) United States
(12) Patent Application Publication
(10) Pub. No.: US 2025/0140920 A1
(43) Pub. Date: May 1, 2025

(54) HIGH-PERFORMANCE ORGANIC LI-BROMINE BATTERY ENABLED BY TWO-ELECTRON REDOX CHEMISTRY

(71) Applicant: City University of Hong Kong, Hong Kong (HK)

(72) Inventors: Chunyi ZHI, Hong Kong (HK); Xinliang LI, Hong Kong (HK); Pei LI, Hong Kong (HK)

(21) Appl. No.: 18/499,255

(22) Filed: Nov. 1, 2023

(51) Int. Cl. H01M 10/0567; H01M 4/13; H01M 4/38; H01M 4/60; H01M 4/62; H01M 4/66; H01M 10/052; H01M 50/417

(52) U.S. Cl. CPC H01M 10/0567; H01M 4/13; H01M 4/381; H01M 4/60; H01M 4/623; H01M 4/625; H01M 4/663; H01M 10/052; H01M 50/417; H01M 2300/0025

(57) ABSTRACT

The present invention provides a high-performance organic lithium-bromine battery enabled by two-electron redox chemistry. The battery includes a bromide-based cathode, an anode, an organic electrolyte disposed in a space between the bromide-based cathode and the anode, featuring an organic solvent with chloride ions-containing additives, and a separator positioned between the bromide-based cathode and anode. The chloride ions within the organic electrolyte trigger a conversion of positively charged bromine ions, facilitating an additional electron transfer and resulting in a capacity of at least 600 mAh g⁻¹, and elevates an output plateau to 3.8 V, thereby achieving an energy density of at least 2000 Wh kg⁻¹_{Br}.

### TECHNICAL FIELD

The present invention generally relates to the fields of battery technology and energy storage. More specifically, the present invention relates to a high-performance organic lithium-bromine battery.

### BACKGROUND OF THE INVENTION

In the rapidly evolving landscape of applied electronics, rechargeable lithium-ion batteries have been at the forefront of technological advancement. However, as the reliance on electronic devices continues to grow, there arises an increasingly pressing concern: the energy density of these batteries. It has become apparent that two pivotal factors, voltage and capacity, seem to exist at opposite ends of a seesaw, eluding efforts for their harmonious reconciliation. This divergence has been observed in the distinction between intercalation-type batteries, which exhibit high voltages but grapple with limited capacity, and conversion-type batteries, where the situation is inversely proportional. In light of this dilemma, there is a critical need to explore novel avenues for enhancing the energy density of batteries.

The number of Li⁺ ions that can be accommodated in intercalated electrodes, such as metal oxides and polyanionic salts, is ultimately limited¹⁻³. Conversely, conversion-type batteries, particularly those employing halogen substances, have displayed remarkable redox potential, even with a single-electron transfer mechanism⁴⁻⁷. On the plus side, the halogen electrodes are still in their infancy, suggesting the vast untapped potential.

As opposed to tinkering with the age-old single-electron conversion mode for improving reaction kinetics or stability, tapping into innovative multi-electron conversion chemistry in halogen systems is undoubtedly a radical boost in electrochemical performance^{8,9}. This approach promises predictable multiples of simultaneous enhancements in voltage and capacity. As exemplified by the activation of a two-electron redox mechanism, the benefits are compelling, including a capacity increase of 138%, a voltage rise of 0.5 V, and, most notably, a remarkable 138% increase in energy density when compared to the single-electron mode⁹. While these advancements are promising, they also highlight the challenges faced by conventional Li-iodine batteries, which still fall short due to their performance limitations. This is evident as more than half of usable capacity lies at 2.9 V and below. This has led to the exploration of bromine (Br) as a promising alternative.

Br exhibits significantly higher redox potential, even in a single-electron mode, surpassing 3.4 V. Moreover, its low mass contributes to elevated capacity and energy density when excluding gaseous F and Cl matter¹⁰. Theoretically, a two-electron mode with the redox couple Br⁰/Br⁺ can produce a twofold higher capacity and an additional high-voltage plateau (up to 3.8 V). However, practical challenges exist, such as the thermodynamic instability of bromine ions in positive valence states in currently available electrolytes. Moreover, in non-flow batteries, elemental Br₂, with its intrinsic fluidity and volatility, is unsuitable for electrodes^{11,12}.

Consequently, there is a need for developing bromine redox chemistry and the identification of adaptable electrodes. The present invention addresses this need.

### SUMMARY OF THE INVENTION

In a first aspect, the present invention provides a high-performance organic lithium-bromine battery enabled by two-electron redox chemistry. The lithium-bromine battery includes a bromide-based cathode; an anode; an organic electrolyte disposed in a space between the bromide-based cathode and the anode, featuring an organic solvent with chloride ions-containing additives; a separator positioned between the bromide-based cathode and anode. The chloride ions within the organic electrolyte trigger a conversion of positively charged bromine ions, facilitating an additional electron transfer and resulting in a capacity of at least 600 mAh g⁻¹, and elevates an output plateau to 3.8 V, thereby achieving an energy density of at least 2000 Wh kg⁻¹_{Br}.

In one embodiment, the anode includes Li plate, Li foil, or graphite.

In one embodiment, the bromide-based cathode includes a current collector, active materials, one or more electrically conductive particles, and a binder. The current collector is selected from the group consisting of carbon cloth, carbon paper, graphite paper, Ti foil/mesh, stainless steel, Al foil, and nickel foam. The active materials are selected from the group consisting of methyl ammonium bromide, methyl ammonium tribromide, tetrabutylammonium bromide, tetrabutylammonium tribromide, cetyl trimethyl ammonium bromide. The one or more electrically conductive particles include super-P, carbon black, ketjen black, active carbon. The binder includes polyvinylidene fluoride, polytetrafluoroethylene, carboxymethyl cellulose.

In another embodiment, the high-performance organic lithium-bromine battery further comprises an organic additive selected from the group consisting of acetonitrile, dimethyl sulfoxide, tetrahydrofuran, propylene carbonate, ethyl methyl carbonate, ethylene carbonate, dimethyl carbonate, vinylene carbonate, propylene sulfite, methyl propionate, fluoroethylene carbonate, and lithium nitrate.

In one embodiment, the chloride ions-containing additives include one or more selected from the group consisting of LiCl, NH₄Cl, CaCl₂, CsCl, FeCl₂, CaCl₂, MgCl₂, KCl, NaCl, AgCl, and ZnCl₂.

In one embodiment, the electrolyte contains Li salts as the solute. The Li salts include LiTFSI, LiOTf, LiPF₆, LiClO₄, LiBF₄, LiAsF₆, LiCF₃SO₃, LiN(CF₃SO₂)₂, LiBOB, LiDFOB, LiFSI, or LiCl.

In one embodiment, the separator comprises polypropylene membrane.

In one embodiment, the battery demonstrates remarkable durability, with a prolonged lifetime of up to 1000 cycles and a negligible capacity attenuation rate of only 4.4% per 100 cycles.

The present invention introduces a high-performance SLB battery that relies on an active bromine salt cathode and utilizes a two-electron transfer chemistry with a Br⁻/Br⁺ redox couple, achieved through electrolyte tailoring. The introduction of NO₃⁻ ions improves the reversibility of the single-electron transition of Br⁻, and even more impressively, the electronegatively coordinated Cl⁻ anions activate the Br⁺ conversion, facilitating an additional electron transfer. The discharge capacity and energy density are 242% and 259% higher than those achieved with the one-electron benchmark.

The two-step conversion mechanism of the present invention exhibits excellent stability, enabling a prolonged lifetime of 1000 cycles, with the capacity attenuation ratio being 4.4% per 100 cycles. These performances currently approach the state-of-the-art of currently established Li-halogen batteries. The established two-electron redox mechanism is considered highly exemplary for diversified halogen batteries.

### BRIEF DESCRIPTION OF THE DRAWINGS

In the following detailed description, reference is made to the accompanying figures, depicting exemplary, non-limiting and non-exhaustive embodiments of the invention. So that the manner in which the above recited features of the present invention can be understood in detail, a more particular description of the invention, briefly summarized above, can be had by reference to the embodiments, some of which are illustrated in the appended figures. It should be noted, however, that the figures illustrate only typical embodiments of this invention and are therefore not to be considered limiting of its scope, for the invention can admit to other equally effective embodiments.

FIG. 1A shows a molecular model of TBABr₃. FIG. 1B depicts a SEM image with EDX mapping data of TBABr₃. FIG. 1C depicts CV curves of the Li∥TBABr₃ battery with different electrolytes at 2.0-3.8 V and 2 mV s⁻¹. FIG. 1D depicts GCD curves of the Li∥TBABr₃ battery with different electrolytes. FIG. 1E depicts CV curves of the Li∥TBABr₃ battery with E2 electrolyte at various scanning rates. FIG. 1F depicts GCD curves of the Li∥TBABr₃ battery with E2 electrolyte at different current densities;

FIG. 2 illustrates EDS spectrum of TBABr₃;

FIG. 3 depicts b values of redox peaks of Li∥TBABr₃ battery with E2 electrolytes;

FIG. 4 depicts dQ/dV curves originated from the GCD curves of Li∥TBABr₃ battery with E2 electrolytes;

FIG. 5 depicts the energy densities at various current densities of Li∥TBABr₃ battery with E2 electrolytes;

FIG. 6A depicts the CV curves of the Li∥TBABr₃ battery with different electrolytes in the 2.0-4.0 V range and FIG. 6B illustrates the corresponding GCD curves. FIG. 6C depicts the CV curves of the Li∥TBABr₃ battery with CE2 electrolyte in different scanning ranges. FIG. 6D depicts the GCD curves of the Li∥TBABr₃ battery with CE2 electrolyte in different scanning ranges. FIG. 6E depicts the enhancement in capacity and energy density resulting from the two-electron transfer with one-electron transfer reaction as the benchmark. FIG. 6F depicts the CV curves of the Li∥TBABr₃ battery with CE2 at different scanning rates with calculated b values of redox peaks;

FIG. 7 depicts b values of redox peaks of Li∥TBABr₃ battery with CE2 electrolytes;

FIG. 8A depicts the LSV curve of the CE2 at 10 mV s⁻¹. FIG. 8B depicts the CV curve of asymmetric Li∥stainless-steel battery at 10 mV s⁻¹. FIG. 8C depicts the GCD curves of the asymmetric Li∥stainless-steel battery at 1 mA, 1 mAh cm⁻² in specific cycles. FIG. 8D depicts the prolonged cyclic performance of a symmetric Li∥Li battery at 1 mA, 1 mAh cm⁻²;

FIG. 9 depicts the CE values of asymmetric Li∥stainless steel battery with CE2 electrolytes;

FIG. 10 depicts the GCD curves of the asymmetric Li∥stainless steel battery at 1 mA, mAh cm⁻² at specific cycles;

FIG. 11 depicts EIS patterns of symmetric Li∥Li batteries with E2 and CE2 electrolytes;

FIG. 12 illustrates the magnified GCD curves of the symmetric Li∥Li battery at 194-200 h and 495-500 h during the prolonged cyclic test;

FIG. 13A depicts the prolonged cyclic performance at 1.5 A g⁻¹ and FIG. 13B depicts the corresponding GCD curves in cycles 2 and 1000. FIG. 13C depicts the rate performance in the current densities of 1-4 A g⁻¹ and FIG. 13D illustrates the corresponding discharge curves. FIG. 13E depicts the dQ/dV curves of Li∥TBABr₃ battery with CE2 electrolyte. FIG. 13F depicts the GITT curve. FIG. 13G illustrates the performance comparison between this work and reported Li-ion batteries;

FIG. 14A depicts the ex-situ high-resolution I 3d XPS spectra at selected SOC points. FIG. 14B depicts the high-resolution Cl 2p XPS spectra at selected SOC points. FIG. 14C depicts the in-situ Raman spectra at selected SOC points. FIG. 14D depicts the in-situ EIS patterns at selected SOC points. FIG. 14E depicts the profiles of Rₒ and R_{ct} values as a function of SOC;

FIG. 15 shows a CR2032-type battery housing with an opening quartz glass window for the in-situ Raman characterization; and

FIG. 16A illustrates a proposed reaction route from Br⁻ to Br⁰ to Br⁺. FIG. 16B depicts the cohesive energy during the charging process for the system with and without Cl⁻. FIG. 16C and FIG. 16D shows the ELF and atomic charge for BrCl, BrCl₂, and BrCl₃, respectively.

### DETAILED DESCRIPTION

Despite the potential of static lithium-bromide (SLB) batteries as conversion-type energy storage technologies, the performance has remained stagnant for decades. The conversion chemistry of bromine shows the greatest potential due to its well-clarified advantages in physicochemical and electrochemical properties, such as low cost, rich valence, and high redox potential. However, all documented lithium-bromine batteries have operated based on the reversible Br⁻/B⁰ conversion, corresponding to the single-electron redox mode. Progress has been hindered by the intrinsic liquid-liquid redox mode and single-electron transfer of these batteries.

The desired reversible conversion of Br⁻/Br⁺ at high potential in a two-electron redox mode has never been realized due to the unstable nature of positive Br⁺ ions in organic electrolytes. The positive Br⁺ conversion is thermodynamically unstable and is associated with poor reversibility and reaction depth. Consequently, all reported lithium-bromine batteries can only achieve a low capacity of 335 mAh g⁻¹ and a low discharge plateau at about 3.4 V vs. Li⁺/Li. Furthermore, in stationary batteries, elemental Br₂, with its intrinsic fluidity and volatility, is unsuitable for use in electrodes.

Accordingly, the present invention provides a static lithium-bromide battery (SLB) fueled by brand-new two-electron redox chemistry features an electrochemically active cathode using haloid materials, a Cl⁻-rich electrolyte, and a separator. The introduced NO₃⁻ enhances the reversible efficiency of Br⁻ ions in a single-electron model.

The lithium-bromine battery is designed for energy storage and incorporates a modified electrolyte strategy to achieve high performance. To replace elemental Br₂, bromide is developed as the source of active bromine, offering improved thermal stability compared to traditional elemental Br₂. The utilization of the newly activated Br⁻/Br⁺ redox process enhances the electrochemical performance significantly, surpassing the capabilities of the traditional Br⁻/Br₃⁻/Br⁰ couple.

In one of the embodiments, the anode may include Li plate, Li foil, and graphite.

In one of the embodiments, the halogen-based cathode includes a current collector, active materials, one or more electrically conductive particles, and a binder. The current collector may be carbon cloth, carbon paper, graphite paper, Ti foil/mesh, stainless steel, Al foil, and nickel foam. The active materials may be methyl ammonium bromide, methyl ammonium tribromide, tetrabutylammonium bromide, tetrabutylammonium tribromide, cetyl trimethyl ammonium bromide. The one or more electrically conductive particles may be upper-P, carbon black, ketjen black, active carbon. The binder may be polyvinylidene fluoride, polytetrafluoroethylene, carboxymethyl cellulose.

Preferably, the active materials are tetrabutylammonium tribromide (TBABr₃).

In one of the embodiments, the halogen-based cathode is bromide-based cathode.

In one of the embodiments, the high-performance organic lithium-bromine battery further includes organic additives, which may be acetonitrile, dimethyl sulfoxide, tetrahydrofuran, propylene carbonate, ethyl methyl carbonate, ethylene carbonate, dimethyl carbonate, vinylene carbonate, propylene sulfite, methyl propionate, fluoroethylene carbonate, and lithium nitrate.

In one of the embodiments, the Cl⁻-rich electrolyte may be an organic Li salt-containing solution. The example of Li salts can be LiTFSI, LiOTf, LiPF₆, LiClO₄, LiBF₄, LiAsF₆, LiCF₃SO₃, LiN(CF₃SO₂)₂, LiBOB, LIDFOB, LiFSI, or LiCl. The Cl⁻-containing additives may be one or more of LiCl, NH₄Cl, CaCl₂, CsCl, FeCl₂, CaCl₂, MgCl₂, KCl, NaCl, AgCl, and ZnCl₂.

In one of the embodiments, the separator may include polypropylene membrane.

In one of the embodiments, the electronegative Cl⁻ anions trigger the Br⁺ conversion, facilitating an additional electron transfer and resulting in a capacity of at least 600 mAh g⁻¹ and a plateau at 3.8 V.

Preferably, the electronegative Cl⁻ anions trigger the Br⁺ conversion, facilitating an additional electron transfer and resulting in a capacity of 653 mAh g⁻¹ and a plateau at 3.8 V.

In one of the embodiments, the lithium-bromide battery presents a high energy density of at least 2000 Wh kg⁻¹_{Br} and exhibits superior cycle stability.

Preferably, the lithium-bromide battery presents a high energy density of 2180 Wh kg⁻¹_{Br}.

Furthermore, the battery demonstrates remarkable durability, with a prolonged lifetime of up to 1000 cycles and a negligible capacity attenuation rate of only 4.4% per 100 cycles.

### EXAMPLES

The examples and embodiments described herein are for illustrative purposes only and various modifications or changes in light thereof will be suggested to persons skilled in the art and are included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### Example 1

### Material and Methods

Tetrabutylammonium tribromide (TBABr₃, Aladdin, >99%), Commercial electrolyte (1.0 M LiTFSI in DME:DOL=1:1 Vol %, DoDoChem), lithium chloride (LiCl, Aladdin, 98%), polyvinylidene fluoride (PVDF, Aladdin) binder, carbon black (Ketjen black EC-600JD, Azko Nobel), N-Methylpyrrolidone (NMP; AR grade, Aladdin), lithium foil (Li, Canrd, >99.9%), copper foil (Cu, Canrd, >99.9%), carbon cloth (HCP331, Canrd), carbon foam (Zhengtairong, >99.9%). All substances were used directly without any treatment.

To collect the microstructure and elemental data of the samples, a field emission scanning electron microscope (SEM; S-4700, Hitachi) equipped with an EDS detector was used. Raman spectra of the samples were recorded using a Horiba LabRam HR Evolution instrument equipped with a 532 nm laser. XPS spectra were acquired using Thermo Fisher ESCALAB XI+ equipment.

### Electrochemical Characterizations

The as-prepared TBABr₃ electrode was utilized directly as the cathode, with Li metal (radius=10 mm) and Celgard 3050 (thickness=20 μm) serving as the anode and separator, respectively, in CR2032 coin cells assembled within an Ar-filled glovebox. All electrochemical tests were carried out at room temperature. Additionally, a special CR2032 coin cell with a quartz window was assembled for in-situ Raman testing. In a symmetric Li∥Li battery configuration, two identical Li metals were used as both the anode and cathode. In the case of an asymmetric Li∥Cu battery, Li metal was utilized as the anode, and Cu metal was employed as the cathode. Linear sweep voltammetry (LSV), cyclic voltammetry (CV), and electrochemical impedance spectroscopy (EIS) measurements were carried out using the multi-functional CHI 760E electrochemical workstation.

### Example 2

### Fabrication of Cl-Saturated Electrolyte

Three commercial electrolytes with different amounts of LiNO₃ were used as the control, namely E0 (1.0 M LiTFSI in DME:DOL=1:1 Vol % without LiNO₃), E1 (1.0 M LiTFSI in DME:DOL=1:1 Vol % with 1% LiNO₃), and E2 (1.0 M LiTFSI in DME:DOL=1:1 Vol % with 2% LiNO₃), while the LiCl was employed as the Cl⁻ source. For all cases, excessive LiCl powders were slowly added to different commercial electrolytes in an Ar-filled glovebox, followed by vigorous stirring for 48 h. Then the mixture was left for 72 h to precipitate the excess LiCl crystal. Finally, the supernatant was extracted as the target product. Three Cl-saturated electrolytes were fabricated and denoted as CE0, CE1, and CE2, respectively, according to the composition difference of commercial electrolytes used. The applied calendering pressures was about 50 MPa. The thickness of the current collector and separator were about 380 μm and 20 μm, respectively. The electrolytes and Li metal anode were overused to ensure the complete electrochemical conversion of the explored cathodes. The lithium metal disc had a diameter of 10 mm and a thickness of 300 μm.

### Example 3

### Fabrication of TBABr₃ Cathodes

TBABr₃ cathode was fabricated via a conventional approach. First, mix the active material (TBABr₃ powders), polyvinylidene fluoride, and carbon black with a weight ratio of 7:2:1 in N-Methylpyrrolidone solvent. After vigorously stirring for 1 hour, a homogeneous slurry was obtained and then poured on carbon cloth substrates. Then the electrode experienced a vacuum-assisted drying process at 70° C. for 72 hours. The mass loading in the TBABr₃ cathode was approximately 1.5 mg cm⁻².

### Example 4

Fabrication of Li∥TBABr₃ Battery with Electrolyte Containing LiNO₃

### One-Electron Transfer Chemistry

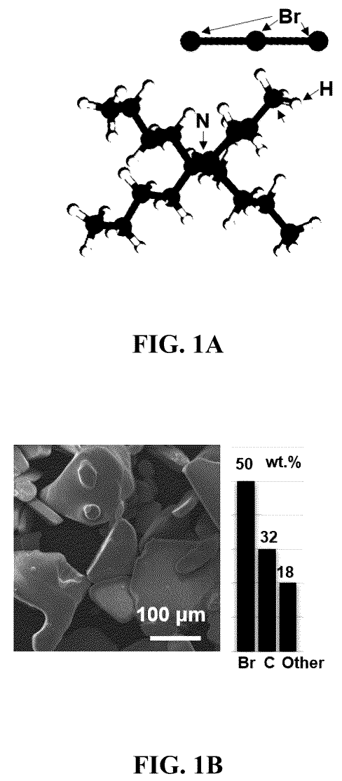

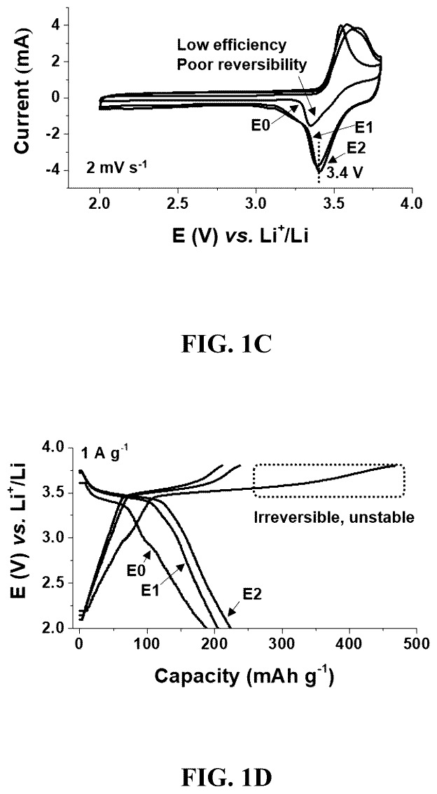

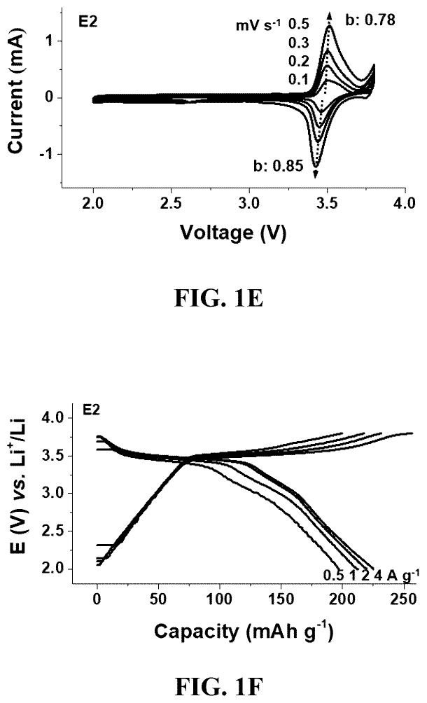

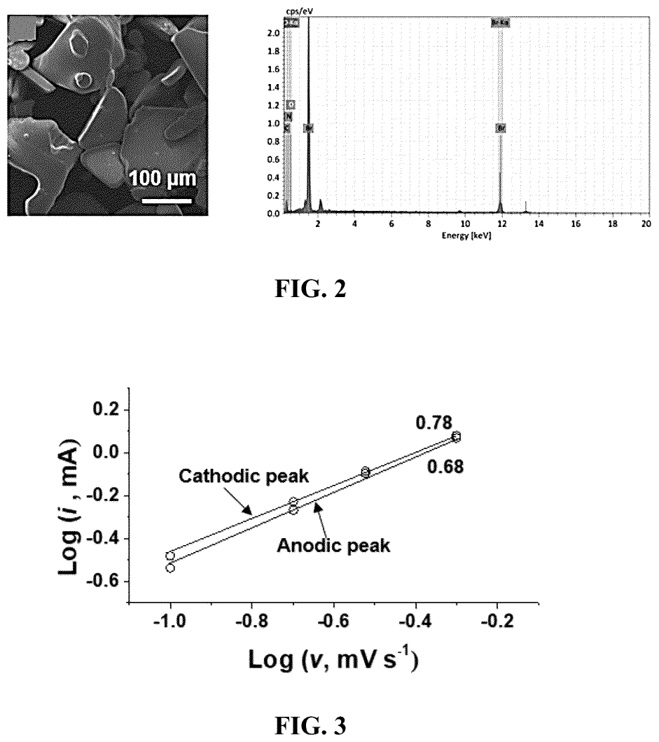

Referring to FIG. 1A, the molecular structure of TBABr₃ was shown, consisting of positively charged tetrabutylammonium (TBA⁺) cations and negatively charged tribromide (Br₃⁻) anions connected by a moderate ionic bond. FIG. 1B and FIG. 2 showed Scanning electron microscopy (SEM) with energy-dispersive X-ray spectroscopy (EDX) elemental mapping, revealing a homogeneous distribution of elemental Br in TBABr₃ powder. Quantitative analysis indicated that the mass fraction of Br in TBABr₃ was approximately 50 wt. %. When TBABr₃ was used as an electrode, the TBA⁺ cations were proven to function as a surfactant to promote electrolyte wetting and inhibit polybromide shuttling.

In one embodiment, a full Li∥TBABr₃ battery having 2032-coin casings, commercial ether-based electrolytes, a polypropylene separator, and a Li metal anode was prepared. The battery was assembled in three ether-based electrolytes with various LiNO₃ additives to regulate the electrolyte stability and redox conditions of the electrolyte. The first electrolyte (E0) had 1.0 M LiTFSI in DME/DOL=1:1 Vol % without LiNO₃. The second electrolyte (E1) had 1.0 M LiTFSI in DME/DOL=1:1 Vol % with 1% LiNO₃. The third electrolyte (E2) had 1.0 M LiTFSI in DME/DOL=1:1 Vol % with 2% LiNO₃. At this stage, an excess of lithium and electrolyte was employed to ensure a thorough reaction of TBABr₃.

Electrochemical testing was conducted on an assembled battery to investigate the direct availability and adaptability of the TBABr₃ cathode. As shown in FIG. 1C, the cyclic voltammetry (CV) curves of the three batteries, obtained at a scanning rate of 2 mV s⁻¹ within a scanning range of 2-3.8 V, exhibited similar electrochemical characteristics. Each of them exhibited a distinct pair of redox peaks. These redox peaks corresponded to the Br⁻/Br₃⁻ couple, with the redox potential being approximately 3.4 V and 3.6 V²⁰.

However, the Li∥TBABr₃ battery with E0 electrolyte resulted in low Coulombic efficiency (CE) and high voltage polarisation, indicating poor reversibility and sluggish kinetics. Electrochemical evidence suggested a substantially weak current response and a cathodic peak at 3.34 V. Therefore, the reduction of Br₃⁻ was not fully reversible. In contrast, the Li∥TBABr₃ batteries with E1 and E2 electrolytes having LiNO₃ additives optimized the reduction reaction in all aspects, as evidenced by the nearly symmetric CV curve and the reduction peak at 3.4 V. Moreover, the slightly larger peak area in the E2 electrolyte represents an improvement in redox completeness.

The aforementioned discrepancies were validated through the galvanostatic charge-discharge (GCD) curve. All electrochemical data were acquired based on the bromine content of the TBABr₃ cathode. Turning to FIG. 1D, when testing the Li∥TBABr₃ battery with an electrolyte without LiNO₃ additives (E0), in which the redox reaction was insufficient, the charging curve extended to 468 mAh g⁻¹, significantly exceeding the discharge capacity of 188 mAh g⁻¹, resulting in a low CE of 40%. The discharge plateau was positioned at 3.45 V, with limited capacity utilization of less than 38%. In contrast, the CE of Li∥TBABr₃ battery with E1 electrolyte reached 97% and the electrolyte had a capacity of 205 mAh g⁻¹, indicating a substantial improvement in redox reversibility. The discharge capacity of E2 electrolyte was further increased to 224 mAh g⁻¹, approaching the theoretical Br⁻/Br₃⁻ redox limit. In addition, both E1 and E2 electrolytes had a plateau at 3.56 V, accounting for 53% of the total capacity. These results demonstrated that LiNO₃ additive played a crucial role in stabilizing redox activity and enhancing kinetics.

The CV curves of Li∥TBABr₃ battery with E2 electrolyte were recorded at various scanning rates to investigate the electrochemical kinetics in detail. FIG. 1E showed a pair of sharp peaks with narrow half-peak widths at 3.42-3.46 and 3.50-3.51 V, respectively, for scanning rates of 0.1-0.5 mV s⁻¹. The dominant coverage area of the peaks on the entire CV curve suggested that the charge transfer process was primarily driven by a reversible redox reaction between Br⁻ and Br₃⁻, with no discernible side reactions being observed.

In order to gain further insights into the charge storage mechanism, the b values of the two peaks were determined using the following equation:

i=av^{b},

where i symbolizes current, v symbolizes scanning rate, and a and b symbolize variables.

If b=0.5, it denoted that the current was controlled by battery-like diffusion behavior, and if b=1, it denoted that the total surface-controlled behavior²¹. Referring to FIG. 1E and FIG. 3, the calculated b value of cathodic peak and anodic peak were 0.78 and 0.68, respectively. It suggested the co-existence of the two aforementioned charge storage mechanisms.

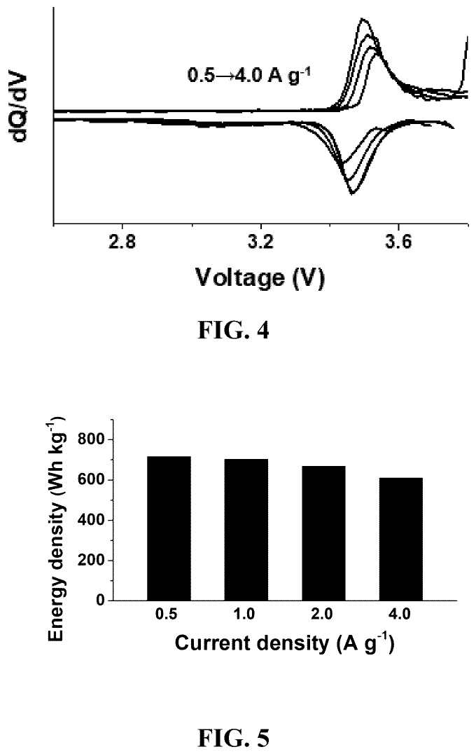

The superior kinetics dampened the current sensitivity of the Li∥TBABr₃ battery and enhanced the rate performance. As shown in FIG. 1F, the GCD curves indicated that the battery achieved capacities of 225, 221, 212, and 196 mAh g⁻¹ at 0.5, 1.0, 2.0, and 4.0 Ag⁻¹, respectively. It could be observed that an eight-fold increase in current yielded 87% capacity retention, and the discharge plateau remained evident in all conditions. Referring to FIG. 4, the dQ/dV curves originated from the GCD curves of Li∥TBABr₃ battery with E2 electrolyte showed paired peaks.

In addition, the large coverage area of the peaks indicated the dominant contribution of the plateau to capacity. Consequently, the maximum energy density was calculated to be 717 Wh kg⁻¹_{Br} (FIG. 5).

### Two-Electron Transfer Chemistry

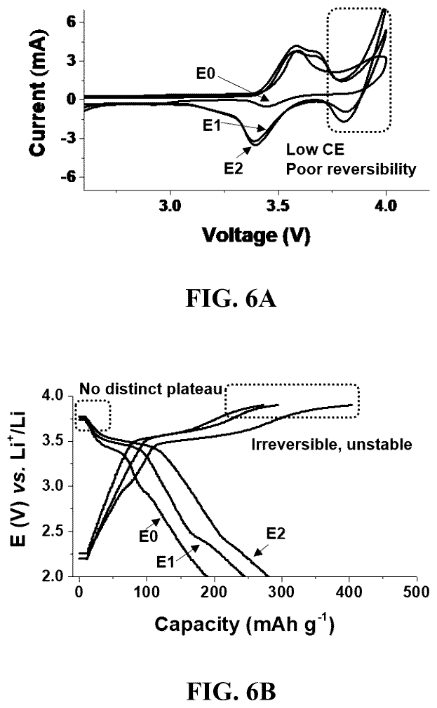

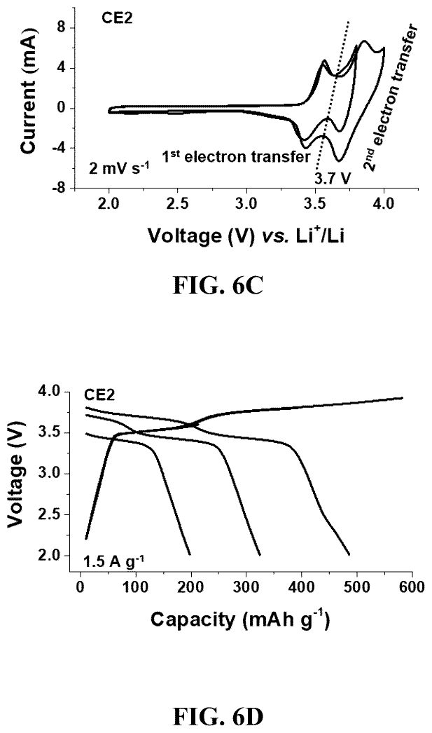

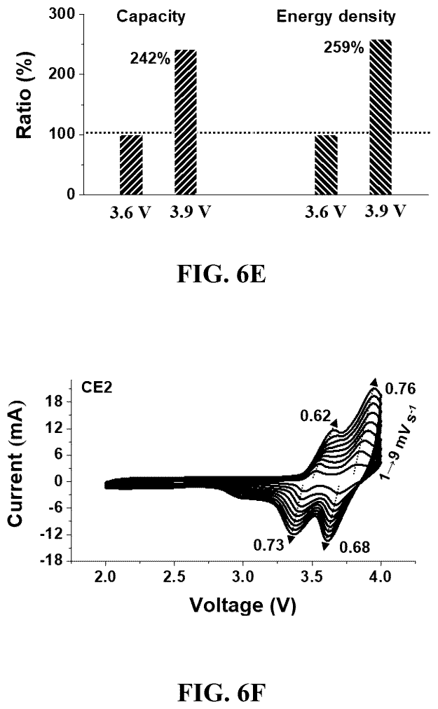

Referring to FIG. 6A, the Li∥TBABr₃ battery with an electrolyte lacking LiNO3 additives also exhibited a trace feature of multi-electron transfer across a broader voltage range of 2-4 V. In addition to the well-known redox reaction of the Br⁻/Br₃⁻ couple at approximately 3.4 V, a new pair of imperceptible peaks was discovered at around 3.8 V (FIG. 6A), corresponding to the redox reaction of Br⁺ cations²². When LiNO3 additives were added, the response current of the new reduction peak increased, indicating an enhancement in the Br⁺ redox process. However, the absolute value of the current was significantly lower than that for the Br⁻/Br₃⁻ couple, indicating low reversibility and CE.

Turning to FIG. 6B, the corresponding GCD curves showed that no new discharge plateau representing Br⁺ reduction appeared on the associated GCD curves, but only one at 3.5 V associated with the Br⁻/Br₃⁻ couple. The plateau at 3.7 V originated from Br⁺ generation, resulting in a significantly higher charging capacity. However, only partial Br⁺ reduction was observed during the discharge stage. At this point, the discharge capacity reached 281 mAh g⁻¹, close to the upper limit of the Br⁻/Br⁰ couple in one-electron transfer mode²³.

### Example 4

Fabrication of Li∥TBABr₃ Battery with CE2 Electrolyte

In this example, the underlying redox mechanism of the Br⁻/Br⁺ couple was elucidated, emphasizing the formation of a stable product, namely Br⁺—Cl⁻₂.

The inhomogeneous electron density of Br⁺ prefers to bond with anions of higher electronegativity, which is considered a breakthrough in the activation of reversible Br⁺ redox reactions. Accordingly, the present invention further introduced saturated Cl⁻ anions in the form of LiCl into the E2 electrolyte (1.0 M LiTFSI in DME/DOL=1:1 Vol % with 2% LiNO₃).

Referring to FIG. 6C, the CV curves of Li∥TBABr₃ with Cl⁻-modified E2 electrolyte (referred to as CE2) were illustrated at 2 mV s⁻¹. In the 2-4 V range, two pairs of prominent redox peaks were observed at 3.42/3.55 V and 3.68/3.85 V, corresponding to the reversible redox reactions of Br⁻ and Br⁺, respectively. It was worth noting that the current response of Br⁺ became significantly enhanced in both the oxidation and reduction stages, even surpassing that of Br⁻. This observation proved that the reversible reaction of Br⁺ had been fully activated with high stability and completeness in the CE2 case, in contrast to the original electrolytes mentioned above. No abrupt increase in current was observed at the cut-off voltage, indicating the stability of CE2 within the specified voltage range.

The entire reaction followed a strict two-step charge transfer process, with no additional redox features identifiable on the CV curves. When the cut-off voltage was adjusted to 3.8 V in the transition zone of both reactions, the CV curve demonstrated a two-step electrochemical feature, with Br⁺ redox occurring in the primary stage. These results confirmed that the Cl⁻ anions were engaged in the generation of Br⁺ at the beginning of the reaction and served a dual activation and stabilization function.

The distinctive feature of a two-electron transfer became more evident in the GCD curves (FIG. 6D). In addition to the Br-excited plateau at 3.4 V, a new sequence of charge/discharge plateaus emerged at 3.4 V/4.2 V, corresponding to the Br⁺ redox process at the 3.92 V cut-off voltage point²⁴. The discharge capacity achieved an unprecedented 568 mAh g⁻¹, and the extension of the new 3.8 V plateau contributed to nearly half of this capacity. As anticipated, no other electrochemical characteristics indicative of supplementary reactions were discernible in the GCD curves. At a cut-off voltage of 3.8 V, two pairs of plateaus appeared. However, the high-voltage plateau was shortened because of the partial Br⁺ redox, consistent with the CV results above. At a voltage of 3.6 V, only one discharge plateau was detected at 3.5 V, with a capacity of 236 mAh g⁻¹. This is because the current reaction had not yet entered the second stage. This new redox chemistry significantly improved electrochemical performance in terms of capacity, voltage, and energy density. Quantitatively, the capacity and energy density of the novel two-electron mode approached 242% and 259%, respectively, those of the conventional one-electron predecessors (FIG. 6E).

### Example 5

### Redox Kinetics of Reversible Br⁺ Redox Reactions

The CV curves at scanning rates of 1-9 mV s⁻¹ within the voltage range 2-4 V were established. As shown in FIG. 6F, two pairs of redox peaks remained in all conditions, with no discernible fluctuations observed. When the scanning rate was increased, the current response of the peaks also increased. Notably, the high-voltage two derived from the Br⁺ redox were always larger. During this interval, the two reduction peaks shifted to higher voltages, transitioning from 3.44 V/3.70 V at 1 mV s⁻¹ to 3.37 V/3.62 V at 9 mV s⁻¹, resulting in a minimal voltage hysteresis of 0.07 V and 0.08 V, respectively. Besides, for Br⁺ redox, a nine-fold increase in scanning rates only slightly worsened the voltage polarisation from 0.13 V (3.70 V/3.83 V) to 0.33 V (3.62 V/3.95 V), representing superior redox kinetics, especially in conversion battery systems.

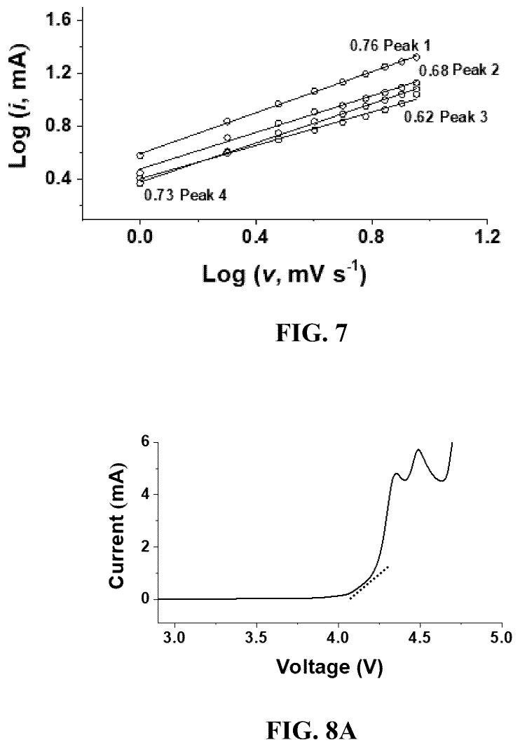

Referring to FIG. 6F and FIG. 7, b values of two peaks of Br⁺ redox were evaluated. The b values were calculated as 0.76 for the cathodic peak and 0.68 for the anodic peak, indicating that the Br⁺ redox process was co-controlled by surface and diffusion-dominated processes and more susceptible to electrochemical batteries.

### Example 6

### Lithium Metal Anode Compatibility Analysis

Although TBABr₃ exhibited outstanding performance in the CE2 electrolyte, it was necessary to ensure its compatibility with the anode for full battery evaluations.

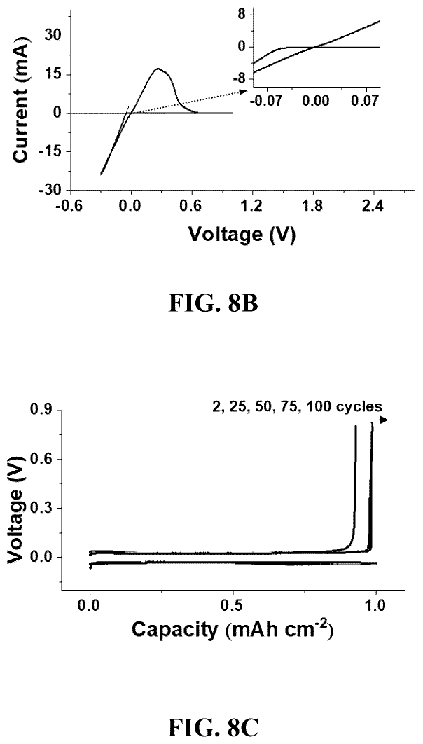

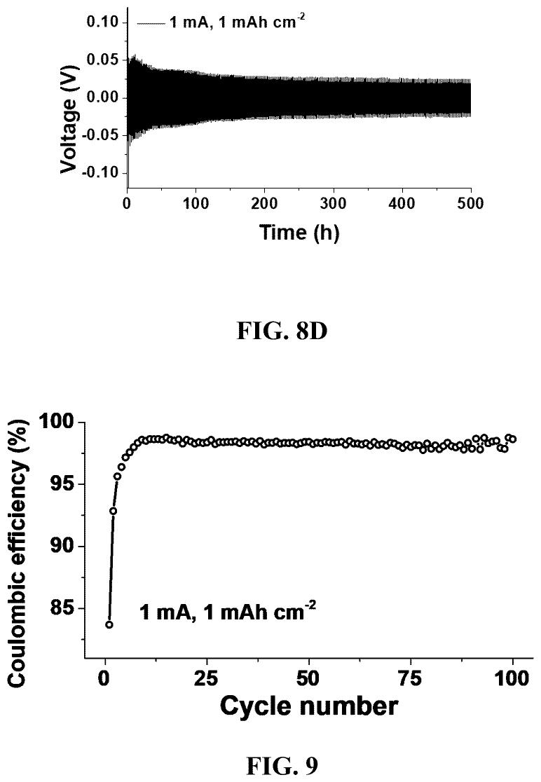

The electrochemical stability of the electrolyte and the reversibility and redox kinetics of the Li anode in it were further analyzed. To determine the stable voltage range of CE2, linear sweep voltammetry (LSV) of an asymmetric Li∥stainless-steel battery with a stainless-steel plate as the working electrode was conducted at a scanning rate of 10 mV s⁻¹. As shown in FIG. 8A, the onset of response current mutation was identified at 4.05 V, before which no decomposition signal was observed, thus confirming the redox stability of the battery. Subsequently, a CV technique was used to evaluate the reversibility of Li plating/stripping in CE2, with a stainless-steel plate used as the working electrode. The CV curves of Li deposition in the cathodic scanning phase and dissolution behavior in the anodic scanning phase were shown in FIG. 8B. A polarization voltage of only 0.05 V resulted from the deposition/dissolution onset potential (−0.05 V versus 0.00 V), indicating the superior redox kinetics of the Li anode.

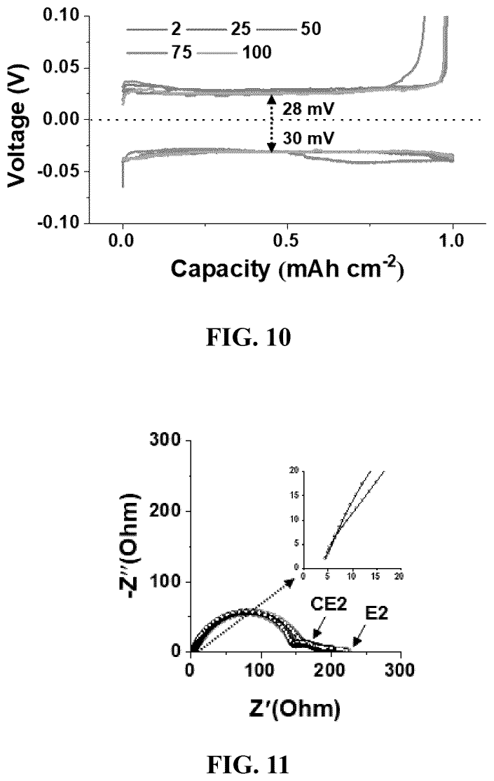

After that, the CE value, an index for evaluating the cyclic stability and reversibility, was recorded in the galvanostatic mode at 1 mA, 1 mAh cm⁻². FIG. 9 showed that the CE value was determined at 84% in the first cycle and rapidly improved to a satisfactory 98% after 6 cycles, followed by stability in the subsequent stage. The associated GCD curves in FIG. 8C and FIG. 10 showed that the voltage polarisation of Li deposition/dissolution was virtually symmetric (28 mV versus 30 mV) and remained stable within 100 cycles. Furthermore, when attention was directed toward a closed cycle, it was observed that the GCD curves remained flat without fluctuating features due to the redox stability.

### Example 7

### Effect of Cl⁻ Anions on the Charge Transfer Process

Electrochemical impedance spectroscopy (EIS) patterns of a symmetric Li∥Li battery with CE2 and E2 electrolytes were provided. The charge transfer resistance (R_{ct}) for CE2 was estimated at 149.6Ω, which was smaller than that for E2 (158.7Ω), indicating that the introduced Cl⁻ anions exerted a positive effect and reduced the Lit diffusion barrier (FIG. 11). Additionally, an improvement was detected in the mass transfer process across the electrode-electrolyte region, as the ohmic resistance (Rₒ) decreased from 5.3 to 4.4Ω.

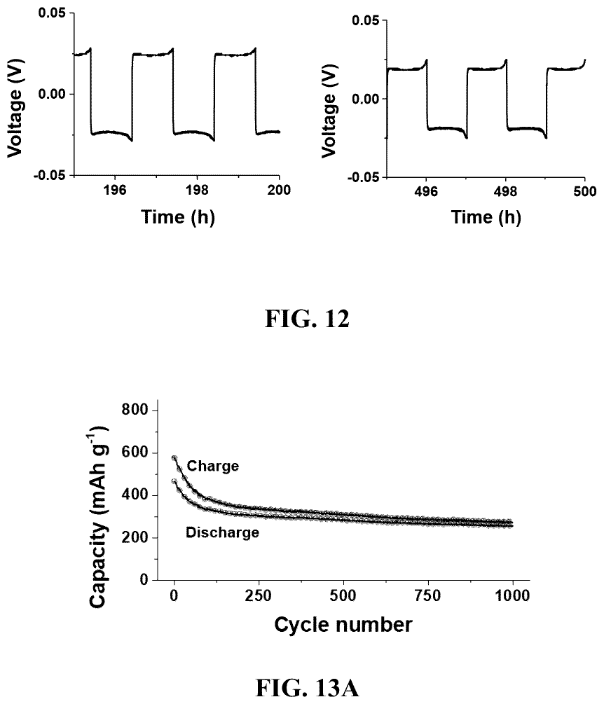

The introduced electrochemical insulating LiCl phase was conducive to redox stability as it brought about a voltage gradient to regulate the electrodeposition of Li ions on the Li surface, thus inhibiting dendrite growth. This phenomenon was confirmed through extended plating/stripping measurements of a symmetric Li∥Li battery. Referring to FIG. 8D and FIG. 12, the voltage profiles as a function of time, recorded at 1 mA, 1 mAh cm⁻² in the CE2 case, remained stable for up to 500 hours without any short-circuit signals.

### Example 8

Electrochemical Performance of Li∥TBABr₃ Battery with CE2 Electrolyte

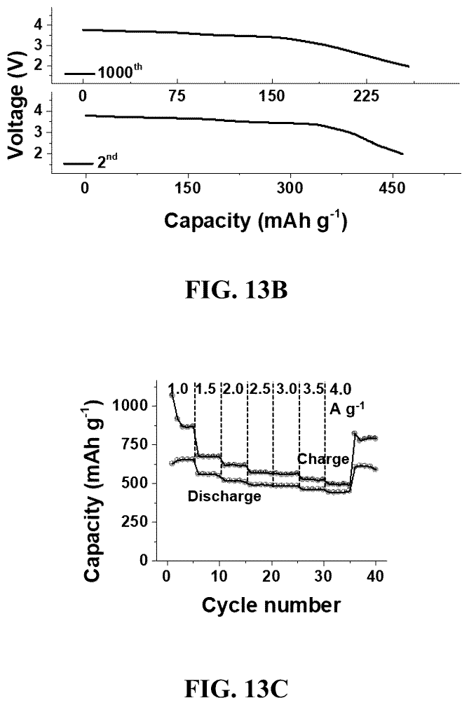

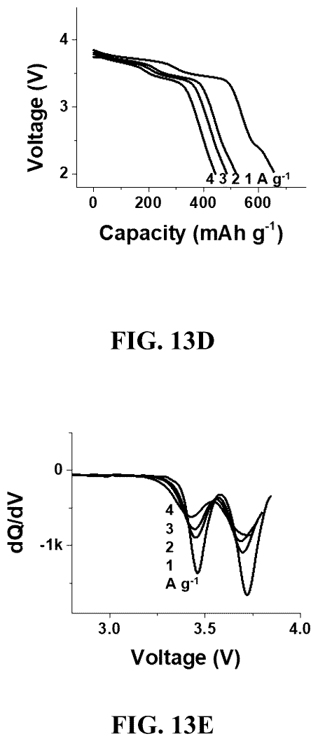

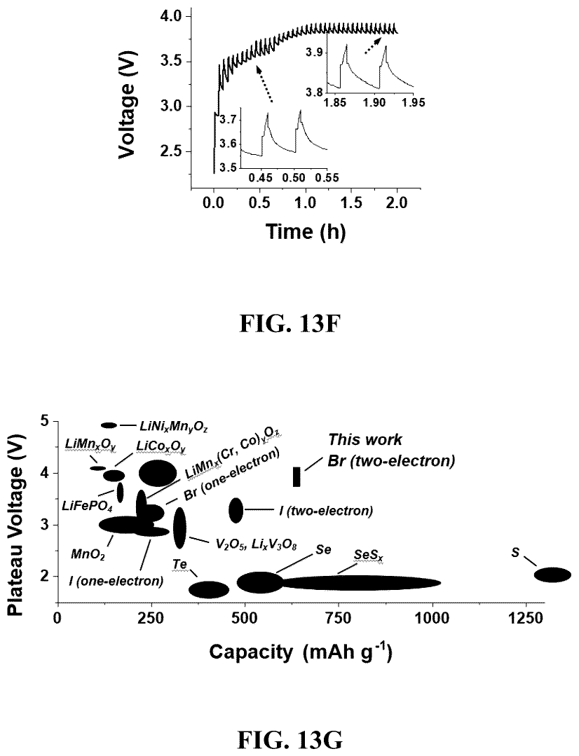

After confirming the steady voltage window of CE2 and its excellent compatibility with Li metal anodes, the electrochemical performance of a full Li∥TBABr₃ battery with innovative two-electron transfer chemistry was comprehensively examined. FIG. 13A depicted the prolonged cyclic capability of the Li∥TBABr₃ battery, demonstrating its reversible operation at 2 A g⁻¹ over 1000 cycles with a capacity fading rate of only 4.4% per 100 cycles.

Turning to FIG. 13B, even after 1000 cycles, the Li∥TBABr₃ battery continued to display two distinct discharge plateaus, signifying a rigorous two-electron transfer mode, similar to the initial cycles. In addition, no detectable electrochemical features originating from side reactions were observed, indicating the long-term stability of such two-electron chemistry. Hence, it was speculated that the capacity degradation observed during cycling was likely due to the inevitable shuttle behavior, leading to the continual loss of active chemicals, rather than degradation of the new redox mode.

The fast kinetics predestined superior rate performance. For instance, at the low current density of 1 Ag⁻¹, the cell discharge capacity reached 653 mAh g⁻¹_{Br}, approaching the theoretical limit of two-electron redox reactions²⁴. Consequently, the energy density reached 2180 Wh kg⁻¹_{Br}.

Furthermore, as illustrated in FIG. 13C, in comparison to the given conversion equivalents, the capacity exhibited low sensitivity to current, with capacity retention exceeding 68% at 4 Ag⁻¹. In addition, two clear plateaus were present in the corresponding discharge curves for all rates, and their trigger voltages and lengths did not drastically diminish with increasing current. The capacity contribution of the 3.8 V-plateau was always more extensive than that of the 3.5 V-plateau (FIG. 13D), with no additional side reactions observed. The aforementioned electrochemical difference could be intuitively observed on dQ/dV curves produced through mathematical processing of the discharge curves.

Referring to FIG. 13E, all dQ/dV curves displayed two distinct peaks, approximately at 3.46 and 3.72 V, mirroring the CV curves mentioned earlier. These peaks arose in discharge plateau regions, in which voltage slowly decayed within a small dV interval, and the peak sharpness was dictated by the plateau flatness. The absolute value of dQ/dV for the 3.72 V peak was typically more extensive than that for the 3.46 V peak, indicating the stability of the reversible redox reaction of fresh Br⁺ at high voltages and its kinetic superiority to other Br⁻ anions²⁵.

A galvanostatic intermittent titration technique (GITT) was used to verify the kinetics-limiting process during charging. As shown in FIG. 13F, the pseudo-equilibrium profile exhibited two well-defined plateau regions in this two-step redox process, with the small curve thickness indicating the excellent kinetics and relaxation voltage of the high-voltage plateau²⁶. The freshly created two-electron redox chemistry simultaneously satisfied the requirements of high-voltage output and large-capacity delivery, thus enabling full TBABr₃ batteries to exhibit excellent electrochemical performance.

To visualize this benefit, the battery was compared with well-known Li-intercalation and Li-conversion batteries regarding voltage plateau and capacity. As summarized in FIG. 13G, compared with traditional Li-halogen (Br or I) counterparts with a one-electron transfer mechanism, the present Li∥TBABr₃ battery was overwhelmingly superior. A voltage plateau of up to 3.8 V was beyond the reach of most conversion systems, such as Li—S, Li—Se, and Li—Te systems^{8, 27, 28}, and it even surpassed the performance of some established intercalated cathodes, such as LiFePO₄ and LiCoxOy. With a capacity of 653 mAh g⁻¹, the new redox chemistry elevated the Li—Br conversion battery from its previous awkward position and endowed it with promising practical capabilities.

### Example 9

### Redox Mechanism Characterization

In this example, multiple experimental characterizations were undertaken, encompassing ex-situ X-ray photoelectron (XPS) spectroscopy, in-situ Raman spectroscopy, and electrochemical impedance spectroscopy (EIS).

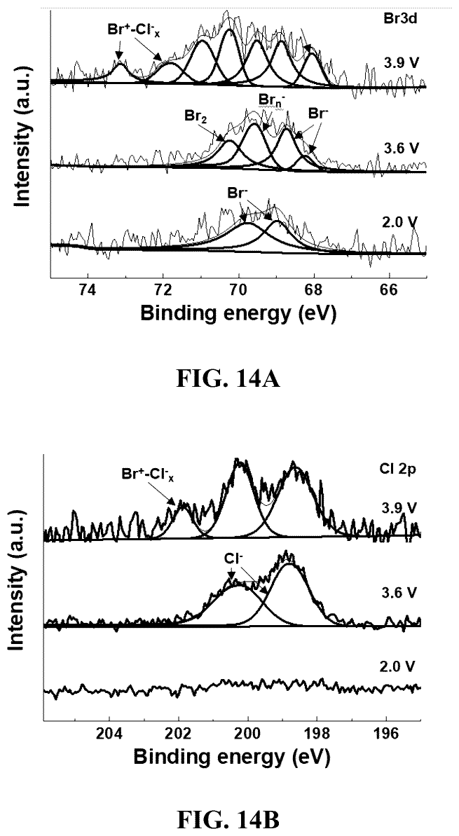

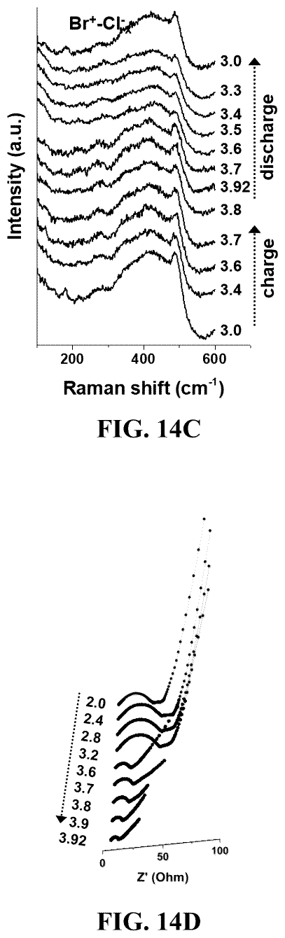

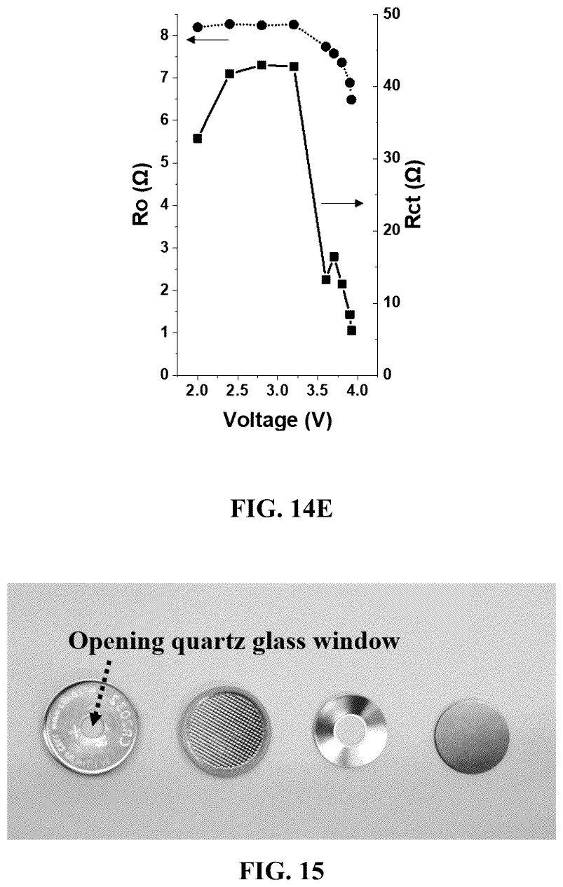

XPS spectroscopy was used to track the chemical valence evolution of Br and Cl in TBABr₃ electrodes for different states of charge (SOC). As shown in FIG. 14A, the progression of charging resulted in the high-resolution Br 3d spectra exhibiting a distinct blue-shift pattern, indicating an increase in the valence of Br. In the fully discharged state, only the characteristic signal of Br⁻ anions could be fitted at 68.9 and 69.8 eV, with a weak Cl signal in the high-resolution Cl 2p spectra presumably originating from surface adsorption or residues (FIG. 14B). At a charging voltage of 3.6 V, both polybromides (Brₙ⁻, n≥3) and Br₂ elements dominated the fitted peaks at 68.2, 68.7, 69.6, and 70.2 eV, corresponding to the oxidation of Br⁻ in the first redox stage^{29,30}. At this point, the Cl signal exhibited a significant increase, with the fitted peaks at 198.8 and 200.2 eV corresponding to Cl⁻ anions. Fitted peaks also appeared at 71.8 and 73.1 eV when the voltage was 3.95 V; these were ascribed to positive Br⁺ cations and suggested the second electron transfer. In addition, the 201.9 eV peak in the Cl 2p spectrum was presumably excited by the redox product of the Br⁺—Cl⁻ₓ complex.

To monitor the real-time evolution of the redox product and identify reversible changes in the entire charge-discharge cycle, Raman spectra were recorded in-situ within a range of 100-700 cm⁻¹ by using a special battery housing with an open quartz glass window (FIG. 14C and FIG. 15). At voltages up to 3.6 V, a new Raman peak emerged at 260-290 cm⁻¹, the intensity of which increased with charging. During the subsequent discharge phase, this signal decayed with decreasing voltage until it entirely vanished at 3.5 V. This reversible signal depicted the synchronized generation and decomposition of Br⁺—Cl⁻ₓ species, aligning with the findings from the XPS analysis

An in-situ EIS technique was used to determine the kinetic differences between the two redox steps. FIG. 14D shows EIS patterns obtained at specific voltage points during the charging stage, with a semicircle in the middle-frequency region and a linear tail in the low-frequency region. Due to the exceptional wettability of both the electrolyte and electrodes, the ohmic resistance (Rₒ) consistently remained at a low level of 6.5-8.2Ω. When the voltage increased, two distinct trends in R_{ct} were observed, namely an increase within the range 2.0-3.2 V (8.2Ω at 2 V vs. 8.3Ω at 3.2 V) and a decrease within the range 3.6-3.9 V (7.7Ω at 3.6 V vs. 6.5Ω at 3.92 V). This distinct phenomenon stemmed from the varying charge transfer mechanisms of the two-step process. An abrupt voltage point was also observed at 3.6 V; at this point, R_{ct} sharply decreased from 8.3 to 7.7Ω, matching the formation voltage of Br⁺ with Cl⁻ involving and is suggestive of the transition of the two redox reactions (FIG. 14E). Subsequently, the charge transfer barrier gradually weakened, resulting in faster kinetics. The pre-enrichment of Cl⁻ anions on the TBABr₃ cathode side during charging could have played a role in this phenomenon.

### Example 10

### The Conversion Mechanism in the Two-Electron Transfer Reaction

In this example, density functional theory (DFT) calculations were conducted.

DFT calculations were performed by using the Vienna ab initio simulation package (VASP)^{13,14}. The electron exchange and correlation were described in generalized gradient approximation (GGA) with the Perdew-Burke-Ernzerhof (PBE) functional¹⁵. The semiempirical Grimme parameter DFT-D3 correction was taken to describe van der Waals corrections¹⁶. The 2×2×1 supercell of TBABr₃ was built and the cutoff energy of 500 eV was used for plane-wave basis sets. The vacuum space was set more than 15 Å along the Z direction. The cutoff maximal residual energy and force were 1×10−5 eV and −0.01 eV/Å, respectively. The charges of atoms in BrCl, BrCl₂ and BrCl₃ were calculated with the Bader analysis program^{17,18}. All the molecular structures were visualized in the VESTA package¹⁹. To measure the stability of the different system, the cohesive energy (E_{C}) was calculated from the DFT calculations,

$${E}_{C} = \frac{m {E}_{B r} + {nE}_{Cl} + {E}_{s u b} + {E}_{s y s}}{m + n} ,$$

where m and n are the numbers of Br, Cl atoms; E_{sys}, E_{Br}, E_{Cl}, and E_{sub} are the energies of the system, isolated atom Br, isolated atom Cl, and the TBABr₃ substrate, respectively. The larger value of E_{C} represents that the corresponding system possesses higher thermodynamic stability.

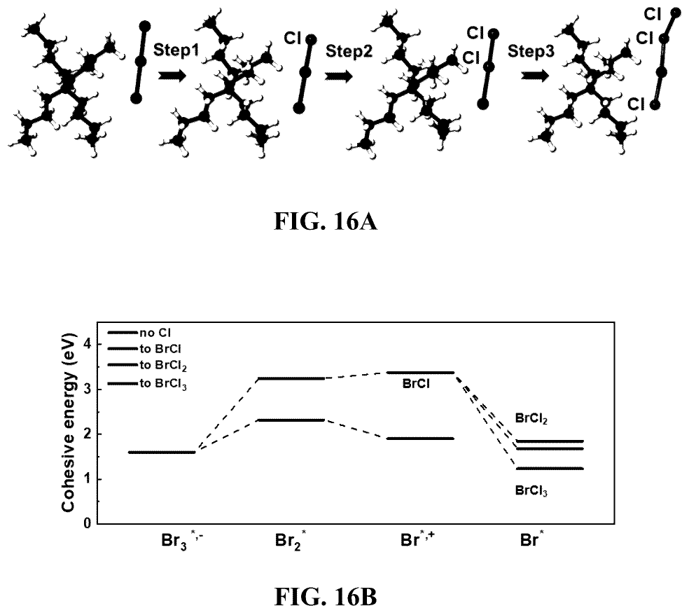

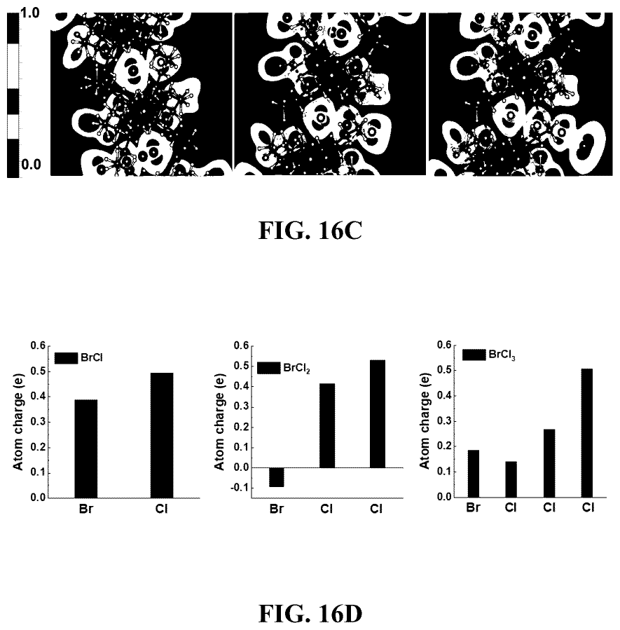

Referring to FIG. 16A, the experimental results proposed a conversion route from Br⁻ to Br⁰ to Br⁺. The profile of cohesive energy for the reaction with and without Cl⁻ was also calculated (FIG. 16B). The results indicated that the Cl⁻ ions promoted the transformation from Br₃⁻ to Br₂ and Br⁺ by lowering the energy barrier, with the energy differences estimated as 0.93 and 1.48 eV, respectively.

Subsequently, three potential redox products, namely BrCl, BrCl₂, and BrCl₃, were proposed and investigated. The results indicated that the cohesive energy of BrCl₂ reached 1.85 eV, which was higher than that of BrCl (1.23 eV) and BrCl₃ (1.68 eV), suggesting the higher thermodynamic stability of BrCl₂.

Moreover, the electron localized function (ELF) for different redox products containing Br was calculated, and it showed that the coupling strength between Cl and Br in BrCl₂ was stronger than in the others (FIG. 16C). Specifically, the atomic charge of the products in FIG. 16D showed that the charge of Br in BrCl, BrCl₂, and BrCl₃ was 0.4, −0.1, and 0.18 e, respectively. The opposing atomic charges between Br and Cl in BrCl₂ aligned with the observed strong coupling strength in ELF. In other words, a combined analysis of the ELF, cohesive energy, and atomic charge indicated that the ultimate redox product tended to be BrCl₂ rather than BrCl or BrCl₃.

In summary, the present invention highlights significant advancements in the realm of energy storage through the strategic use of electrolytes. The incorporation of NO₃⁻ additives improves the redox efficiency of Br⁻ conversion in the single-electron model, and further introducing saturated Cl⁻ enables an unprecedented reversible reaction of Br⁺. These breakthroughs have enabled the creation of a high-performance solid-liquid battery centered on the two-electron transfer chemistry of the Br⁻/Br⁺ couple.

Utilizing the modified CE2 electrolyte in conjunction with a Li metal anode has yielded exceptional results. The implementation of a novel electron shuttle has propelled the discharge capacity to an impressive 653 mAh g⁻¹_{Br}, while the output plateau has surged to 3.8 V, resulting in an outstanding energy density of approximately 2180 Wh kg⁻¹_{Br}.

Furthermore, the battery demonstrates remarkable durability, with a prolonged lifetime of up to 1000 cycles and a negligible capacity attenuation rate of only 4.4% per 100 cycles.

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

### REFERENCES: THE DISCLOSURES OF THE FOLLOWING REFERENCES ARE INCORPORATED BY REFERENCE

1. Lu, Y. & Chen, J. Prospects of organic electrode materials for practical lithium batteries. Nature Reviews Chemistry 4, 127-142, doi:10.1038/s41570-020-0160-9 (2020).
2. Zhuo, Z. et al. Cycling mechanism of Li2MnO3: Li—CO2 batteries and commonality on oxygen redox in cathode materials. Joule 5, 975-997 (2021).
3. Lee, J. et al. Unlocking the potential of cation-disordered oxides for rechargeable lithium batteries. Science 343, 519-522, doi:10.1126/science. 1246432 (2014).
4. Zhu, G. et al. Rechargeable Na/Cl(2) and Li/Cl(2) batteries. Nature 596, 525-530, doi:10.1038/s41586-021-03757-z (2021).
5. Li, X. et al. Activating the I 0/I+ redox couple in an aqueous I 2-Zn battery to achieve a high voltage plateau. Energy & Environmental Science (2018).
6. Gao, L. et al. A High-Performance Aqueous Zinc-Bromine Static Battery. iScience 23, 101348, doi:10.1016/j.isci.2020.101348 (2020).
7. Yoo, S. J. et al. Fundamentally Addressing Bromine Storage through Reversible Solid-State Confinement in Porous Carbon Electrodes: Design of a High-Performance Dual-Redox Electrochemical Capacitor. J Am Chem Soc 139, 9985-9993, doi:10.1021/jacs.7b04603 (2017).
8. Zou, Y. et al. A four-electron Zn-12 aqueous battery enabled by reversible I−/I 2/I+ conversion. Nature Communications 12, 1-11.
9. Li, X. L. et al. Two-Electron Redox Chemistry Enabled High-Performance Iodide-Ion Conversion Battery. Angewandte Chemie-International Edition 61, e202113576, doi:ARTN e20211357610.1002/anie.202113576 (2022).
10. Manthiram, A., Yu, X. W. & Wang, S. F. Lithium battery chemistries enabled by solid-state electrolytes. Nature Reviews Materials 2, 1-16, doi:ARTN 1610310.1038/natrevmats.2016.103 (2017).
11. Biswas, S. et al. Minimal architecture zinc-bromine battery for low cost electrochemical energy storage. Energy & Environmental Science 10, 114-120, doi:10.1039/c6ee02782b (2017).
12. Li, X. et al. Confining Aqueous Zn—Br Halide Redox Chemistry by Ti(3)C(2)T(X) MXene. ACS Nano 15, 1718-1726, doi:10.1021/acsnano.0c09380 (2021). ADDIN EN.REFLIST
13. Kresse G, Furthmüller J. Efficiency of ab-initio total energy calculations for metals and semiconductors using a plane-wave basis set. Computational materials science 1996, 6(1): 15-50.
14. Kresse G, Furthmüller J. Efficient iterative schemes for ab initio total-energy calculations using a plane-wave basis set. Physical review B 1996, 54(16): 11169.
15. Perdew J P, Burke K, Ernzerhof M. Generalized gradient approximation made simple. Physical review letters 1996, 77(18): 3865.
16. Grimme S. Semiempirical GGA-type density functional constructed with a long-range dispersion correction. Journal of computational chemistry 2006, 27(15): 1787-1799.
17. Henkelman G, Arnaldsson A, Jónsson H. A fast and robust algorithm for Bader decomposition of charge density. Computational Materials Science 2006, 36(3): 354-360.
18. Yu M, Trinkle D R. Accurate and efficient algorithm for Bader charge integration. The Journal of chemical physics 2011, 134(6): 064111.
19. Momma K, Izumi F. VESTA: a three-dimensional visualization system for electronic and structural analysis. Journal of Applied crystallography 2008, 41(3): 653-658.
20. Xi, X. L. et al. Non-aqueous lithium bromine battery of high energy density with carbon coated membrane. Journal of Energy Chemistry 26, 639-646, doi:10.1016/j.jechem.2017.04.013 (2017).
21. Yang, Q. et al. Activating C-Coordinated Iron of Iron Hexacyanoferrate for Zn Hybrid-Ion Batteries with 10 000-Cycle Lifespan and Superior Rate Capability. Adv Mater 31, e1901521, doi:10.1002/adma.201901521 (2019).
22. Yang, C. et al. Aqueous Li-ion battery enabled by halogen conversion-intercalation chemistry in graphite. Nature 569, 245-250 (2019).
23. Popat, Y. et al. Carbon Materials as Positive Electrodes in Bromine-Based Flow Batteries. Chempluschem 87, e202100441, doi:ARTN e20210044110.1002/cplu.202100441 (2022).
24. Xu, Y., Xie, C., Li, T. & Li, X. A High Energy Density Bromine-Based Flow Battery with Two-Electron Transfer. ACS Energy Letters 7, 1034-1039 (2022).
25. Ji, B. F., Zhang, F., Song, X. H. & Tang, Y. B. A Novel Potassium-Ion-Based Dual-Ion Battery. Advanced Materials 29, 1700519, doi:ARTN 170051910.1002/adma.201700519 (2017).
26. Li, X. et al. A high-energy sulfur cathode in carbonate electrolyte by eliminating polysulfides via solid-phase lithium-sulfur transformation. Nat Commun 9, 4509, doi:10.1038/s41467-018-06877-9 (2018).
27. Xu, J., Ma, J., Fan, Q., Guo, S. & Dou, S. Recent progress in the design of advanced cathode materials and battery models for high-performance lithium-X (X=O2, S, Se, Te, I2, Br2) batteries. Advanced Materials 29, 1606454 (2017).
28. Ma, J., Liu, M., He, Y. & Zhang, J. Iodine Redox Chemistry in Rechargeable Batteries. Angew Chem Int Ed Engl 60, 12636-12647, doi:10.1002/anie.202009871 (2021).
29. Li, P. et al. Luminescence enhancement of CsPbBr 3 quantum dot glasses induced by two unexpected methods: mechanical and hydration crystallization. Journal of Materials Chemistry C 8, 473-480 (2020).
30. Li, Y. et al. Synthesis of partially hydrogenated graphene and brominated graphene. Journal of Materials Chemistry 22, 15021-15024, doi:10.1039/c2jm32307a (2012).

1. A high-performance organic lithium-bromine battery enabled by two-electron redox chemistry, comprising:
a bromide-based cathode;
an anode;
an organic electrolyte disposed in a space between the bromide-based cathode and the anode, featuring an organic solvent with chloride ions-containing additives;
a separator positioned between the bromide-based cathode and anode,
wherein the chloride ions within the organic electrolyte trigger a conversion of positively charged bromine ions, facilitating an additional electron transfer and resulting in a capacity of at least 600 mAh g⁻¹, and elevates an output plateau to 3.8 V, thereby achieving an energy density of at least 2000 Wh kg⁻¹_{Br}.

2. The high-performance organic lithium-bromine battery of claim 1, wherein the anode comprises Li plate, Li foil, or graphite.

3. The high-performance organic lithium-bromine battery of claim 1, wherein the bromide-based cathode comprises a current collector, active materials, one or more electrically conductive particles, and a binder.

4. The high-performance organic lithium-bromine battery of claim 3, wherein the current collector is selected from the group consisting of carbon cloth, carbon paper, graphite paper, Ti foil/mesh, stainless steel, Al foil, and nickel foam.

5. The high-performance organic lithium-bromine battery of claim 3, wherein the active materials are selected from the group consisting of methyl ammonium bromide, methyl ammonium tribromide, tetrabutylammonium bromide, tetrabutylammonium tribromide, cetyl trimethyl ammonium bromide.

6. The high-performance organic lithium-bromine battery of claim 3, wherein the one or more electrically conductive particles comprise super-P, carbon black, ketjen black, or active carbon.

7. The high-performance organic lithium-bromine battery of claim 3, wherein the binder comprises polyvinylidene fluoride, polytetrafluoroethylene, or carboxymethyl cellulose.

8. The high-performance organic lithium-bromine battery of claim 1, wherein the high-performance organic lithium-bromine battery further comprises an organic additive selected from the group consisting of acetonitrile, dimethyl sulfoxide, tetrahydrofuran, propylene carbonate, ethyl methyl carbonate, ethylene carbonate, dimethyl carbonate, vinylene carbonate, propylene sulfite, methyl propionate, fluoroethylene carbonate, and lithium nitrate.

9. The high-performance organic lithium-bromine battery of claim 1, wherein the chloride ions-containing additives comprise one or more selected from the group consisting of LiCl, NH₄Cl, CaCl₂, CsCl, FeCl₂, CaCl₂, MgCl₂, KCl, NaCl, AgCl, and ZnCl₂.

10. The high-performance organic lithium-bromine battery of claim 1, wherein the electrolyte comprises Li salts as the solute.

11. The high-performance organic lithium-bromine battery of claim 10, wherein the Li salts comprise LiTFSI, LiOTf, LiPF₆, LiClO₄, LiBF₄, LiAsF₆, LiCF₃SO₃, LiN(CF₃SO₂)₂, LiBOB, LiDFOB, LiFSI, or LiCl.

12. The high-performance organic lithium-bromine battery of claim 1, wherein the separator comprises polypropylene membrane.

13. The high-performance organic lithium-bromine battery of claim 1, wherein the battery demonstrates remarkable durability, with a prolonged lifetime of up to 1000 cycles and a negligible capacity attenuation rate of only 4.4% per 100 cycles.
